(19) United States
(12) Patent Application Publication
(10) Pub. No.: US 2004/0151155 A1
(43) Pub. Date: Aug. 5, 2004

(54) Method for activating a connection in a communications system, mobile station, network element and packet filter

(76) Inventor: Jarkko Jouppi, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/471,511

(22) PCT Filed: Mar. 14, 2001
(86) PCT No.: PCT/EP01/02870

(51) Int. Cl. H04J 3/24; H04L 12/28; H04L 12/56

(52) U.S. Cl. 370/349; 370/401

(57) ABSTRACT

The invention relates to a method for activating a user data transfer connection (11) between a mobile station (1) and a node (2) of a communications system. For some of the connections (11) the mobile station (1) sends packet filter values (16) to said node (2), the node (2) assigning downlink packets (6) received to a connection (11) of which the filter values (16) match with values included in said packet (6). In order to enable an activation of a connection while at least some filter values required for the connection are not yet available, it is proposed that in such a case, when activating a new connection, the mobile station (1) sends for said connection (11) at least one filter value (16) to said node (2) that does not match with the corresponding value of any possible packet (6). Alternatively, the mobile station (1) transmits a parameter (17) to the node (2) indicating whether the new connection is allowed to be used.

### FIELD OF THE INVENTION

The invention relates to methods for activating a user data transfer connection in a communications system including at least one mobile station and at least one said node being accessible by the mobile station via a wireless access network, and said node operating as a gateway to a packet-switched network. The invention equally relates to mobile stations, a packet filter, a network element, and communications systems that can be used in such an activation.

### BACKGROUND OF THE INVENTION

Different connections used for routing user data between a mobile station and a packet-switched network can be employed e.g. for being able to provide different Qualities of Service (QoS) to transmission requested for different applications by a single mobile station.

The use of such individually established connections is described e.g. for UMTS (Universal Mobile Telecommunications System) in the technical specification 3G TS 23.060 V3.4.0 (2000-07): “Technical Specification; 3rd Generation Partnership Project; Technical Specification Group Services and System Aspects; General Packet Radio Service (GPRS); Service description; Stage 2 (Release 1999)”. This document defines a service description for the packet domain, which includes the General Packet Radio Service (GPRS) in GSM (Global System for Mobile Communications) and UMTS. The packet domain uses a packet-mode technique to transfer high-speed and low-speed data and signalling in an efficient manner. The radio subsystem and the network subsystem are strictly separated, therefore the network subsystem can be reused with different radio access technologies. For example, a common packet domain Core Network can be used for both GSM and UMTS.

In the system described in the specification, a mobile station MS is e.g. able to access UMTS Radio Access Network, the UMTS Radio Access Network forming together with mobile stations a radio subsystem of a communications system. The UMTS Radio Access Network is further connected to a serving GPRS Support Node (SGSN) through an Iu interface. The SGSN is responsible for keeping track of the location of the individual mobile station and for performing security functions and access control. The SGSN in turn is connected via an Internet Protocol (IP) based packet domain PLMN (Public Land Mobile Network) backbone network to a gateway GPRS (General Packet Radio System) Support Node (GGSN). The system part from SGSN to GGSN forms the network subsystem of the communications system. The GGSN finally is connected to external packet-switched networks in order to provide the communications system with a possibility for interworking with the external packet-switched networks.

A mobile station can exchange data with the external packet switched networks via the GGSN. More specifically, the GGSN routes downlink packets coming from an external packet switched network to the SGSN to which a specific mobile station is presently assigned. Moreover, the GGSN is able to forward uplink packets originating from a mobile station to an external network.

For the transfer of user data between a mobile station and an external network, an activated PDP context is utilised, which defines the route to be taken by specific user data. Such PDP contexts constitute possible connections that the invention relates to. By GPRS subscription, to each mobile station one or more Packet Data Protocol (PDP) addresses are subscribed. For the same PDP address and therefore for the same mobile station, several PDP contexts may be activated at the same time for different applications. Each PDP address is therefore described by one or more PDP contexts in the mobile station, the SGSN and the GGSN. The first activated context is called the primary PDP context and the subsequently activated contexts are called secondary PDP contexts. A PDP context is activated based on communications between the respective mobile station, the SGSN and the GGSN.

The mobile station is responsible for creating or modifying PDP contexts and their Quality of Service (QoS), but the SGSN may restrict requested QoS attributes given its capabilities, the current load, and the subscribed QoS profile. Each secondary PDP context can be associated with a Traffic Flow Template (TFT). The TFT contains attributes that specify an IP header filter that is used to direct specific data packets received from an interconnected external packet data network to the PDP context to which the TFT is associated. The GGSN uses for a new PDP context the same external network as used by the already activated PDP context(s) for that PDP address. In order to be able to use a new PDP context, the GGSN generates a new entry in its PDP context table, and stores the TFT. The new entry allows the GGSN to route PDP PDUs (Protocol Data Unit) via different GTP (GPRS Tunnelling Protocol) tunnels between the SGSN and the external PDP network.

The TFTs are defined by the mobile station for which the corresponding PDP context is activated. The mobile station should define TFTs in such a way that downlink PDP packets are routed to a PDP context that best matches the QoS requested by the receiver of this PDU. For each uplink PDP packet, the mobile station should choose the PDP context that best matches the QoS requested by the sender of this PDP packet. Packet classification and routing within the mobile station is an internal mobile station matter.

TFTs are used for PDP types IP and PPP (Point-to-Point Protocol) only. For PDP type PPP a TFT is applicable only when IP traffic is carried over PPP. If PPP carries header-compressed IP packets, then a TFT cannot be used.

A secondary PDP context activation procedure may be used to activate a PDP context while reusing the PDP address and other PDP context information from an already active PDP context, but with a different QoS profile. The secondary PDP context activation procedure may be executed without providing a TFT to the newly activated PDP context if all other active PDP contexts for this PDP address and Access Point Name (APN) already have an associated TFT, otherwise a TFT shall be provided. The secondary PDP context activation procedure may only be initiated after a PDP context is already activated for the same PDP address and APN.

In addition to an activation of a PDP context by a mobile station, a network-requested PDP context activation procedure car, be carried out, which allows the GGSN to initiate the activation of a PDP context. When receiving a PDP PDU as downlink packet, the GGSN checks if a PDP context is established for that PDP address. If no PDP context has been previously established the GGSN may try to deliver the downlink packet by initiating the network-requested PDP context activation procedure. Network requested PDP context activation Procedure essentially requests the mobile station to start the context activation procedure with certain APN, PDP type and PDP address. The mobile station can reject the network initiated context activation or accept it. To support network-requested PDP context activation the GGSN has to have static PDP information about the PDP address. To determine whether network-requested PDP context activation is supported for a PDP address the GGSN checks if there is static PDP information for that PDP address. Once these checks have been performed the GGSN may initiate the network-requested PDP context activation procedure.

FIG. 1 illustrates the usage of several PDP contexts established between a GGSN and a mobile station in a UMTS/GPRS communications system.

In the figure, a mobile station 1 and a GGSN 2 are depicted. Further, three PDP contexts 3, 4, 5 are shown between the mobile station 1 and the GGSN 2. The GGSN operates as a gateway between an IP-based packet domain PLMN backbone network of the UMTS/GPRS communications system and an external packet-switched network. The mobile station 1 accesses the IP-based packet domain network and thereby the GGSN via a radio access network and a SGSN to which it is presently assigned and which are not shown in the figure. The PDP contexts 3, 4, 5 define different routes associated with different QoS between the GGSN 2 and the SGSN.

The mobile station 1 is presently running three different applications. Each of the three applications requires an exchange of user data with the external packet-switched network with a different QoS. In order to enable such an exchange of user data, three PDP contexts 3, 4, 5 were activated between the GGSN 2 and the mobile station 1, more specifically between the GGSN 2 and the SGSN to which the mobile station is assigned. The PDP context that was activated first for a first application is the primary PDP context 3. The other two PDP contexts that were established in addition for a data transfer for the other two applications constitute a first and a second secondary PDP context 4, 5. It is also possible that a mobile station 1 runs a single application using different PDP contexts 3, 4, 5 for different flows needing different QoS.

In case several PDP context 3, 4, 5 are activated as in the example of FIG. 1, user data that is to be transmitted in either direction has to be assigned to the PDP context that was activated for the specific application or group of applications to which the user data belongs.

In uplink transmission, the mobile station 1 knows which flows have to be directed to which PDP contexts 3, 4, 5, since it knows the application from which they proceed. The uplink user data arriving at the GGSN 2 via one of the three PDP contexts is then forwarded as uplink IP packets to the external packet switched network.

In downlink direction, the GGSN 2 receives downlink IP packets 6 from the external packet switched network that belong to one of the three applications and that are to be transmitted to the mobile station 1. Also the GGSN 2 therefore has to know on a packet-by-packet basis which one of the activated PDP contexts 3, 4, 5 should be selected for transferring the respective user data to the mobile station 1. The mobile station 1 transmits the necessary information for the distribution of packets to the different PDP contexts 3, 4, 5 to the GGSN 2 during activation of the respective PDP context.

For the activation of each secondary PDP context 4, 5, the mobile station 1 sends the necessary information in form of a separate TFT 7 to the GGSN 2. A transmission of such a TFT 7 is also indicated in FIG. 1. Each TFT 7 includes one or more packet filters. Each included packet filter in turn includes as packet filter components one or more TCP/UDP/IP (Transmission Control Protocol/User Datagram Protocol/Internet Protocol) header field values. Such header field values are also included in all received downlink IP packets 6. Available header fields are the source IP address, i.e. the peer's IP address, the source port, the destination port, a DiffServ (differentiated services) field, a flow label for IPv6 (IP version 6), a protocol number for IPv4 (IP version 4) or a next header for IPv6, and finally a Security Parameter Index (SPI) that may be used in connection with IP security (IPSec).

In the GGSN 2, the received TFT packet filter is stored. Subsequently, the header field values of each incoming downlink. IP packet 6 can be compared with the values of the packet filters of all TFTs provided for the presently activated PDP contexts. For transmission, the GGSN 2 selects the PDP context for which all TFT packet filter values match with the header field values of the downlink IP packet. The packet filters therefore enable an identification of the PDP context to be used for a certain flow or a certain group of flows of user data.

As mentioned above, only secondary PDP contexts require the usage of TFTs. The primary PDP context is used as a default, i.e. in cases where no TFT information matches with a downlink packet. On the other hand, each secondary PDP context activation procedure is generally required to include a TFT information, since according to the mentioned standard, at the most one PDP context associated with the same PDP address may exist at any time with no TFT assigned to it. Therefore, only in case the original primary PDP context has been deleted in the meantime, a TFT associated to a new PDP context is not necessary. Each new or modified TFT further is required to include at least one valid packet filter. Hence, it is not possible to leave the TFT empty in a secondary PDP context activation. If it is left empty, the PDP context will not be activated and an error code will be returned to the mobile station.

This approach leads to problems in some kinds of implementation. In an example implementation, a PDP context activation takes place when an application requests to open a PDP context. At this time, the mobile station mobile terminal has not yet got knowledge about the header fields that will be used for this application and that therefore have to be included in the TFT for the corresponding PDP context. The missing knowledge becomes available at the earliest when a communication socket is opened by the application and an IP address and a TCP/UDP port is bound to the socket, a socket being always tied to one PDP context. Some other TFT related information, like e.g. flow labels, may only become available even in some later phase. This results in the problem that filter information has to be sent already in a TFT packet filter utilised in a secondary PDP context activation, even though the mobile station might not be provided with the necessary filter information yet.

Though the standard does not require all the packet filter values to be used, the packet filter components that are chosen by the mobile terminal manufacturer might not be available when a PDP context is opened. In the following, some examples for such values that are not present when requesting an activation of a new PDP context are given: The peer's IP address might not yet be available because the Domain Name Server (DNS) query is done at a later time, and to do the query the PDP context must be opened unless the primary context is used for the DNS query. Further, the mobile station does not know which Flow label value the peer uses for this traffic before it receives the first packet from the peer. The DiffServ field may also not be known before some information is received from the peer. Finally, when an IPSec field is used, the Security Parameter Index would be suitable for packet filtering. However, the value to be used as a SPI, which is an integer value, is chosen by the mobile station at the same time that the algorithms, keys, and other parameters of the security association are negotiated between the two parties. Thus, it is likely that the SPI cannot be decided before the two parties are communicating with each other.

As can be seen from the above examples, on the one hand, several of the packet filter components may not become known until a connection is opened to the peer device, while on the other hand, the connection to the peer requires opening of a PDP context.

### SUMMARY OF THE INVENTION

It is an object of the invention to provide a method, a mobile station, a packet filter, a network element, and a communications system that enable an activation of a user data transfer connection while at least some filter information required for the connection is not yet available.

This object is reached according to a first aspect of the invention with a method for activating a user data transfer connection in a communications system including at least one mobile station and at least one node, said node being accessible by the mobile station via a wireless access network and said node operating as a gateway to a packet-switched network, wherein between said mobile station and said node user data can be transferred via activated connections. In this method, the mobile station sends for at least some of to be activated connections at least one packet filter value to said node. The node assigns packets received via said packet-switched network to a connection of which received packet filter values match with the values included in said packet. In case at least one packet filter value requested by a manufacturer to be set is not available at the mobile station when a new connection is to be activated, the mobile station sends for said connection at least one packet filter value to said node that does not match with the corresponding value of any possible packet.

For the first aspect of the invention, further a packet filter is proposed that can be associated with a specific connection to be used for transferring packets with specific user data between a mobile station and a node of a communications system. The packet filter can be stored in said node, which compares values of stored packet filters associated with specific connections with corresponding values of received downlink packets and which assigns downlink packets to connections with matching values. The packet filter comprises at least one packet filter value that does not match with a corresponding value in any possible downlink packet. It thus constitutes a dummy packet filter.

Equally for the first aspect of the invention, a mobile station for a radio communications system is proposed that is able to access a node operating as a gateway to a packet-switched network via a wireless access network. The mobile station comprises means for associating packet filter values with connections that are to be used for transferring user data between said node and said mobile station. The packet filter values associated with a connection are selected in a way that they correspond to values of packets received by said node from said packet-switched network that are to use said connection. Said means of the mobile station are moreover are adapted to associate, in case that not all packet filter values required for a connection are known by said mobile station, at least one packet filter value with said connection, said value not being suited to match with a corresponding value of any possible packet. The mobile station further comprises means for transmitting packet filter values associated with a specific connection to said node.

A corresponding communications system preferably comprises a mobile station, a radio access network, a support node connected to said radio access network, and a gateway connected to said support node via a core network, which gateway provides an access to an external packet-switched network. The mobile station is suited to access said radio access network and it includes means for associating packet filter values with a connection that is to be used for transferring specific user data between said mobile station and said gateway. The associated filter values are selected in a way that they correspond to header field values of packets received by the gateway from said external packet-switched network that are to use said context. This communications system is then further adapted for the two different aspects of the invention.

For the first aspect of the invention applied to such a communications system, said means of the mobile station for associating packet filter values are moreover designed for associating in case that not all the packet filter values required for a connection with which packet filter values are to be associated are known, at least one packet filter value with said connection which is not suited to match with a corresponding value of any possible downlink packet. The mobile station further includes means for transmitting packet filter values associated with a connection to the gateway of the system. The gateway finally includes means for comparing received packet filter values with corresponding header field values of received packets, and for assigning the packets to contexts with matching filter values.

The stated object is reached alternatively according to a second aspect of the invention with a method similar to the method of the first aspect. But instead of sending for a connection at least one packet filter value to the node that does not match with the corresponding value of any possible downlink packet in case at least one required packet filter value is not available at the mobile station when activating a new connection, the mobile station transmits a parameter to the node for at least some of connections that are to be activated, said parameter indicating whether the respective connection is available to be assigned by the node to received packets.

Corresponding to the first aspect of the invention, also for second aspect of the invention a mobile station for a radio communications system is proposed. This mobile station is similar to the mobile station of the first aspect of the invention. But instead of means designed for associating, in case that not all the filter values required for a connection are known, at least one packet filter value with said connection which is not suited to match with a corresponding value of any possible downlink packet, the mobile station of the second aspect of the invention comprises means designed for setting a parameter to a first predetermined value in case all the filter values required for a connection with which packet filter values are to be associated are known and to a second predetermined value in case not all filter values required for a specific connection with which packet filter values are to be associated are known. Further, the mobile station of the second aspect of the invention comprises means not only for transmitting associated packet values but also for transmitting the set value of the parameter associated to a specific connection to the node.

For second aspect of the invention, in addition a network element is proposed. This network element comprises a node operating as a gateway between a radio communications network and a packet-switched network. The node in turn includes means for receiving from a mobile station packet filter values associated with a specific connection that is to be used for a transfer of user data between said node and said mobile station and for receiving a parameter associated with such a specific connection indicating whether the specific connection is to be used. The node further includes means for storing the received filter values and the corresponding value of the parameter. Finally, the node includes means for comparing values included in a packet received from the packet switched network with those stored packet filter values associated with a connection with which a parameter value is associated that indicates that said connection is available to be used, and for assigning said packet to a connection with packet filter values matching to the values of said packet for a transfer of said packet to said mobile station.

A corresponding communication system for the second aspect of the invention is identical to the first part of the communications system proposed for the first aspect of the invention. For this aspect, said means of the mobile station are moreover designed for setting a parameter to a first predetermined value in case all filter values required for a connection with which packet filter values are to be associated are known and to a second predetermined value in case not all filter values required for a connection with which packet filter values are to be associated are known yet. The mobile station further includes means for transmitting packet filter values associated with a specific connection and the set value of the parameter to the gateway. The gateway includes means for comparing header field values of packets received from the packet-switched network with received packet filter values with which the first predetermined value of said parameter is associated, and for assigning the received packets to connections with associated matching packet filter values.

The required packet filter values include all those values defined, e.g. by the manufacturer of a mobile station, as minimum set of values that are to be set for requested connections and that are not allowed to be ignored or set to a default value by the mobile station.

The invention proceeds from the idea that information should be provided to the node of a communications system operating as a gateway to a packet-switched network in case an activated connection cannot be used yet because of missing packet filter values.

In the first aspect of the invention, the required information is supplied by providing the node with a packet filter including at least one value that cannot possibly match to the corresponding value of packets that are to be assigned to activated connections. Thereby, valid packet filter values can be provided in order to enable the activation of the connection, while at the same time preventing that the connection is used for any data transmission as long as the correct filter values are not known.

In the second aspect of the invention, the required information is supplied to the node by providing the node for each connection with an additional parameter that can take one of at least two different possible values. The first value indicates that the connection is not yet to be used because some of the required packet filter values are still missing, while the second value indicates that all the required packet filters are provided and that thus the connection can be used. Also this solution allows the activation of a connection while filter values are still unknown. For the second aspect of the invention, however, the node has to be designed in a way that it is able to understand the received parameter and to act accordingly, while the first aspect leads to an automatic neglecting of a new connection in case the correct filter values are not known, since when comparing values in incoming packets to all packet filter values no matching filter values are found.

A possible employment of the invention has to be seen in particular in communications systems using UMTS. In accordance with the mentioned standard, in this case the node would be a GGSN, the mobile station would have access to the GGSN via a UMTS radio access network, an SGSN and an IP-based packet domain PLMN backbone network, the connection that is to be activated would be a secondary PDP context, and the filter values would be sent by the mobile station to the GGSN in a packet filter of a TFT associated with a secondary PDP context. The invention can be used, however, as well for any other communications system using individually established connections for transmissions between a mobile station and a packet-switched network.

If used with UMTS, the first aspect of the invention has the advantage that it can be applied within the scope of the specifications in the mentioned UMTS standard. The second aspect of the invention on the other hand has the advantage that there is no need for artificial dummy packet filters.

In one preferred embodiment of the first aspect of the invention, the packet filter values transmitted by a mobile station to the node operating as a gateway are replaced with other packet filter values as soon as the packet filter values required for the connection are known. This substitution automatically enables the node to apply subsequently arriving downlink packets to the correct connection.

In the second aspect of the invention, instead of dummy packet filter values, a parameter is provided that can be used for controlling the assignment of packets to connections. The parameter can be associated either directly to the respective connection or to some message transmitted for this connection, like to a TFT for a secondary PDP context. On the one hand, the value of said parameter preferably indicates that no packets are to be assigned to the corresponding connection in case at least one of the packet filter values required for the connection is not yet available. In case a TFT is transmitted for such a PDP context, the TFT can either not include any packet filters at all or include packet filters with values known at this point of time. On the other hand, the value of said parameter preferably indicates that packets can be assigned to the connection if the corresponding packet values match with the packet filter values associated with the connection in case all packet filter values required for said connection are available.

In a preferred embodiment of the second aspect of the invention, the packet filter values required for a connection are sent from the mobile station to the node as soon as they are all known. In addition, the value of the parameter associated to the respective connection should be exchanged and transmitted to the node which allows the node to use the connection defined by the packet filter values now associated with said connection.

For UMTS, a mechanism to replace existing packet filters is described in the mentioned UMTS standard. It is stated that during the modification of a TFT, one or more existing packet filters can be modified or deleted, or a new packet filter can be created. In order to modify an existing packet filter, the new values for the packet filter attributes along with the packet filter identifier is sent from the mobile station to the GGSN. A GPRS-attached mobile station can initiate the activation, modification, and deactivation functions at any time for a PDP context in the mobile station, the SGSN, and the GGSN.

The preferred embodiments of the invention become apparent from the subclaims.

### BRIEF DESCRIPTION OF THE FIGURES

In the following, the invention is explained in more detail with reference to drawings, of which

FIG. 1 illustrates the usage of TFTs in a UMTS based network;

FIG. 2 illustrates a TFT concept employed for an embodiment of the first aspect of the invention; and

FIG. 3 illustrates a TFT concept employed for an embodiment of the second aspect of the invention.

### DETAILED DESCRIPTION OF THE INVENTION

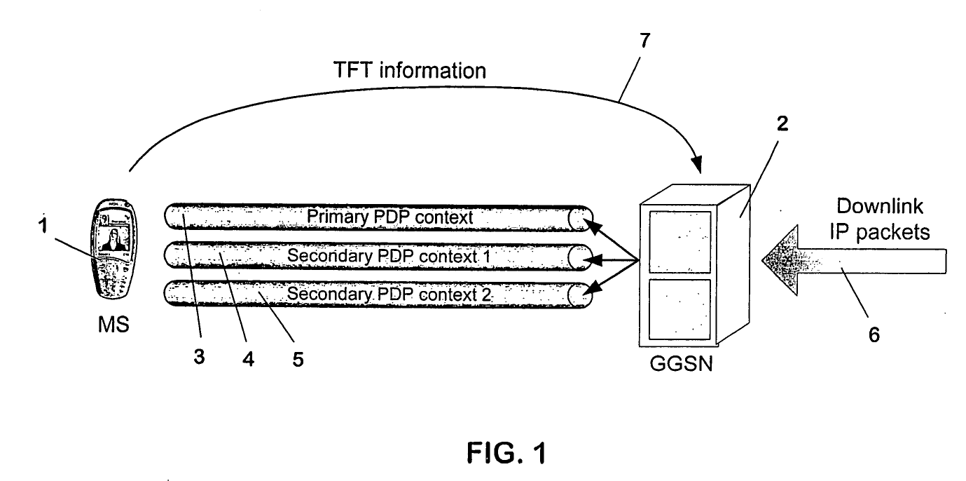

FIG. 1 has already been described with reference to the background of the invention.

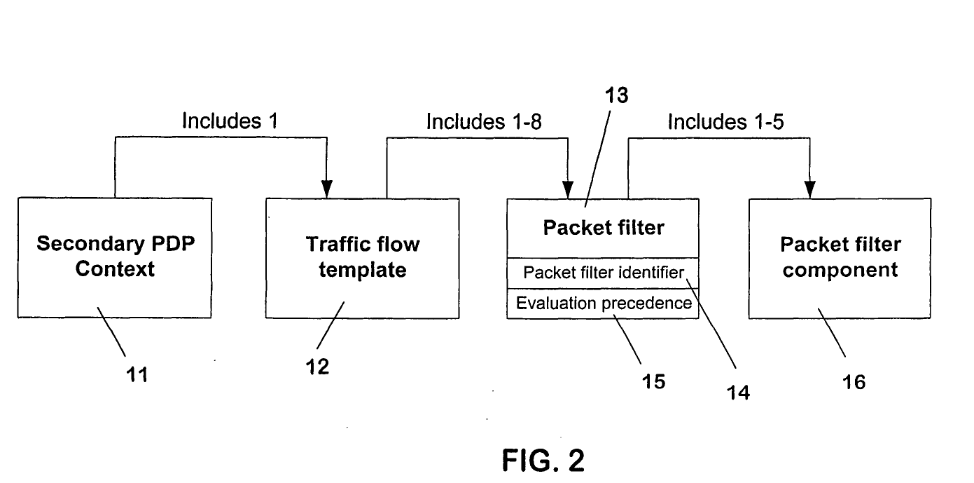

FIG. 2 illustrates the structure of a TFT that can be used in a system like the one described with reference to FIG. 1. Reference signs of elements depicted only in FIG. 1 will be used as well in the description of FIG. 2. The structure corresponds to the mentioned UMTS standard which is used without modification as basis for the first aspect of the invention.

As can be seen in FIG. 2, to each secondary PDP context 11 there is associated one traffic flow template TFT 12. Each TFT 12 in turn includes between one and eight packet filters 13. A packet filter identifier 14 and an evaluation precedence 15 are associated with each packet filter 13. Moreover, each packet filter 13 includes values for one to five packet filter components 16. As mentioned above, these filter components 16 may be one or several of the source IP address, the source port, the destination port, a DiffServ field, a flow label, a protocol number or a next header, and a Security Parameter Index.

A mobile station 1 that wants to activate a secondary PDP context 11 has to sent a TFT 12 including at least one packet filter 13 to the GGSN 2 together with the request for activating the PDP context 11. In case the mobile station 1 does not know the values of all the requested filter components 16 needed for this PDP context 11 yet, it is not allowed to send an empty TFT 12 with no packet filters at all, because an empty TFT would not be a valid TFT and with a non-valid TFT 12 the requested PDP context 11 would be rejected.

According to the first aspect of the invention, the mobile station 1 therefore generates a neutral and non-effective packet filter 13, including at least a value for one of the packet filter components 16. In order to be non-effective, the values of these filter components 16 are chosen in a way that they cannot possibly match with any existing downlink flows. The generated packet filter 13 therefore constitutes a dummy packet filter. With this dummy packet filter 13 it is prevented that the operation of other applications and possibly existing PDP context mapping rules are disrupted, since it is ensured that no packets of other applications are wrongly assigned to the new context. The filter components 16 of the dummy packet filter 13 can include e.g. a destination port with a value that is never used, a source IP address that cannot even exist or a protocol number 255 which is reserved by IANA (Internet Assigned Numbers Authority) but which is never used by any protocol.

Since the TFT 12 includes a valid packet filter 13, the request is not rejected and the context 11 activated. The TFT 12 is stored in the GGSN 2.

Subsequently, upon reception of a downlink packet 6, the GGSN 2 evaluates whether there is a match of values in the header field of the downlink packet 6 with the values of components 16 in any of the stored packet filters 13. There may be several packet filters 13 stored for one PDP context 11 in order to enable a group of flows with different header field values to use the same PDP context 11. First the packet filter 13 of all stored TFTs 12 that has the smallest evaluation precedence 15 index is evaluated. In case the packet filter values of this TFT 12 do no match to the values in the header field of the received packet 6, the GGSN 2 proceeds with the evaluation of packet filters 13 in increasing order of their evaluation precedence 15 index, as long as no packet filter 13 with matching filter values 16 is found and as there are any remaining packet filters 13. The packet filter 13 containing matching values is identified by the packet identifier 14, which can be used to determine the PDP context 11 to which the TFT 12 with said packet filter 13 is associated.

As a first possibility, a downlink packet 6 arrives at the GGSN 2 which is destined for a formerly established PDP context 11, for which context 11 the values of all needed packet filter components 16 are known and stored in the GGSN 2. In this case, the correct matching packet filter 13 will be found by the GGSN 2, since the dummy packet filter does not match to any possible downlink packet 6. The found matching packet filter 13 corresponds to a specific activated PDP context 11, which is used for forwarding the downlink packet 6 to the mobile station 1 for which it is destined.

As a second possibility, a downlink packet 6 arrives at the GGSN 2 which is destined for the newly activated PDP context 11, for which the correct packet filter components 16 are missing. The values of the header fields of the downlink packet 6 that are used for comparison do not match to the values of components 16 of any of the packet filters 13 stored in the GGSN 2. In particular they do not match to the values in the dummy packet filter 13 corresponding to the new context 11 to which the downlink packet 6 would have to be assigned, since the dummy packet filter 13 comprises at least one value that does not match to any possible value. Accordingly, the primary PDP context is by default assigned to the downlink packet 6.

With the activation of the PDP context 11 enabled by the dummy packet filter 13, a connection to the peering device can be established so that the values of the until then not known packet filter components 16 can be obtained. As soon as the mobile station 1 receives information about the values to be used in packet filtering for the newly activated context 11, it transmits a new TFT 12 to the GGSN 2 with at least one packet filter 13 comprising the correct values of packet filter components 16. In the GGSN 2, the TFT 12 with the new packet filter 13 is substituted for the provisionally stored TFT 12 with the dummy packet filter 13. In the following, also the new PDP context 11 can be assigned to downlink packets 6 just like the earlier established PDP contexts, in case the header field values of the downlink packets 6 match to the values of the components 16 in the substitute packet filter or filters 13.

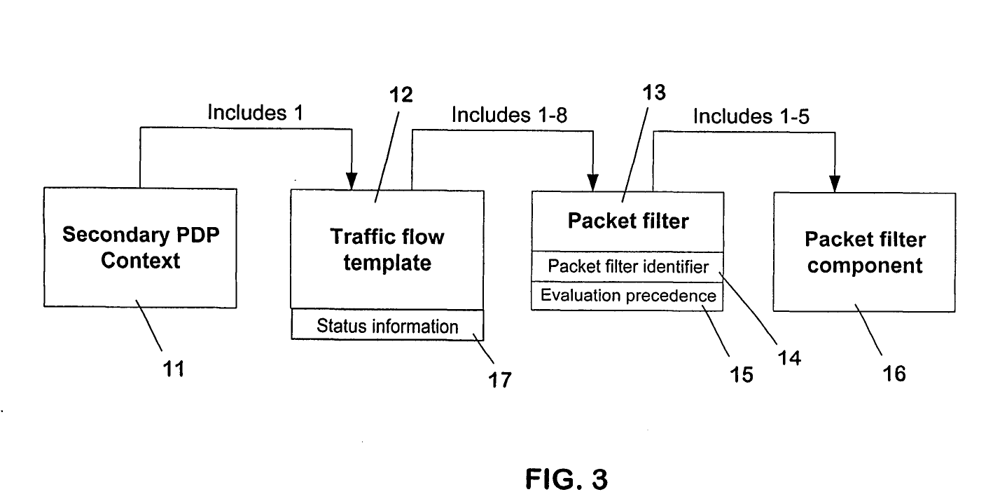

FIG. 3 illustrates another structure of a TFT that can be used in a system like the one described with reference to FIG. 1. Reference signs of elements depicted only in FIG. 1 will be used as well in the description of FIG. 3.

FIG. 3 is identical to FIG. 2 except that to each TFT 12 an additional information field is assigned. This information field is called in the figure validity information 17. The information field contains a parameter that can have at least two different values.

A mobile station 1 that wants to activate a secondary PDP context 11 has to sent together with the request for the PDP context 11 activation an associated TFT 12 to the GGSN 2. The information field 17 added according to the second aspect of the invention offers an additional option in the TFT 12. In case the mobile station 1 wants to activate a secondary PDP context 11 for which not all the needed values of packet filter components 16 are known yet, the parameter in the information field 17 is set to a value that indicates that the packet filtering components 16 for this PDP context 11 are not yet available and that therefore, the PDP context 11 is not to be used for any downlink packets 6 yet. In case the mobile station 1 wants to activate a secondary PDP context 11 for which all values of filter components 16 are already known or in case the mobile station 1 received missing filter values of components 16 for an already activated PDP context 11, it sends a TFT 12 for the respective context 11 to the GGSN 2 in which the information field 17 is set to a value that indicates that the values of all the needed packet filter components 16 are known and included in the TFT 12 and that therefore, the PDP context 11 can be assigned to downlink packets 6 arriving at the GGSN 2 with matching header field values.

The GGSN 2 in the embodiment of the second aspect of the invention is designed in a way that it is able to understand the meaning of the value of the parameter in the information field 17. Therefore, it evaluates all incoming downlink packets 6 as described with reference to FIG. 2, but it excludes all TFTs 12 from the evaluation that are not to be used according to their information field 17.

It becomes apparent from the description of the embodiments of the two aspects of the invention that both aspects are suited to solve the problem related to the very first packet filter utilised in a PDP context activation when some filter values are not yet known.

1. Method for activating a user data transfer connection (11) in a communications system including at least one mobile station (1) and at least one node (2), said node being accessible by the mobile station (1) via a wireless access network, and said node operating as a gateway to a packet-switched network, wherein between said mobile station (1) and said node (2) user data can be transferred via activated connections (11), wherein for at least some of to be activated connections (11) the mobile station (1) sends at least one packet filter value (16) to said node (2), wherein the node (2) assigns packets (6) received via said packet-switched network to a connection (11) of which received packet filter values (16) match with the values included in said packet (6), and wherein in case at least one required packet filter value (16) is not available at the mobile station (1) when a new connection is to be activated, the mobile station (1) sends for said connection (11) at least one packet filter value (16) to said node (2) that does not match with the corresponding value of any possible packet (6).

2. Method according to claim 1, wherein packet filter values (16) received by the node (2) that do not match with the corresponding value of any possible packet (6) are replaced with packet filter values required for the activated connection (11) as soon as they are known by the mobile station (1).

3. Method according to claim 1 or 2, wherein the wireless access network is a UMTS (Universal Mobile Telecommunications System) radio access network, wherein the node is a GGSN (Gateway General Packet Radio System Support Node) (2), wherein the mobile station (1) has access to the GGSN (2) via the UMTS radio access network, an SGSN (Serving General Packet Radio Service Support Node) and an IP (Internet Protocol) based packet domain PLMN (Public Land Mobile Network) backbone network, wherein the to be activated connection (11) is a secondary PDP (Packet Data Protocol) context, and wherein the packet filter values (16) are send by the mobile station (1) to the GGSN (2) in a packet filter (13) of a TFT (Traffic Flow Template) (12) associated with the to be activated secondary PDP context (11).

4. Packet filter (13) that can be associated with a specific connection (11) to be used for transferring packets with specific user data between a mobile station (1) and a node (2) of a communications system and that can be stored in said node (2), the node (2) comparing values (16) of stored packet filters (13) associated with specific connections with corresponding values of received downlink packets (6) and assigning downlink packets (6) to connections (11) with matching values, wherein the packet filter (13) comprises at least one packet filter value (16) that does not match with a corresponding value in any possible downlink packet (6).

5. Mobile station (1) for a radio communications system, said mobile station being able to access a node (2) operating as a gateway to a packet-switched network via a wireless access network, said mobile station (1) comprising:
means for associating packet filter values (16) with connections (11) that are to be used for transferring user data between said node (2) and said mobile station (1), the packet filter values (16) being selected such that they correspond to values of packets (6) received by said node (2) from said packet-switched network that are to use said connection (11), wherein said means are adapted to associate, in case that not all packet filter values (16) required for a connection (11) are known by said mobile station (1), at least one packet filter value (16) with said connection (11), said value (16) not being suited to match with a corresponding value of any possible packet (6); and
means for transmitting packet filter values (16) associated with a specific connection (11) to said node (2).

6. Communications system comprising a mobile station (1), a radio access network, a support node connected to said radio access network, and a gateway (2) connected to said support node via a core network, said gateway (2) providing access to an external packet-switched network, wherein said mobile station (1) is arranged to access said radio access network and includes means for associating packet filter values (16) with a connection (11) that is to be used for transferring specific user data between said mobile station (1) and said gateway (2), the associated packet filter values (16) being selected such that they correspond to header field values of packets (6) received by said gateway (2) from said external packet-switched network that are to use said PDP context (11), said means being adapted to associate, in case that not all packet filter values (16) required for a connection (11) with which packet filter values are to be associated are known, at least one packet filter value (16) with said connection (11) which is not suited to match with a corresponding value of any possible packet (6), wherein said mobile station (1) further includes means for transmitting packet filter values (16) associated with a connection (11) to said gateway (2), and wherein said gateway (2) includes means for comparing received packet filter values (16) with corresponding header field values of received packets (6), and for assigning the packets (6) to connection (11) with matching filter values.

7. Method for activating a user data transfer connection (11) in a communications system including at least one mobile station (1) and at least one node (2), said node being accessible by the mobile station (1) via a wireless access network, and said node operating as a gateway to a packet-switched network, wherein between said mobile station (1) and said node (2) user data can be transferred via activated connections (11), wherein for at least some of to be activated connections (11) the mobile station (1) sends at least one packet filter value (16) to said node (2), wherein the node (2) assigns packets (6) received via said packet-switched network to a connection (11) of which received packet filter values (16) match with the values included in said packet (6), and wherein the mobile station (1) transmits a parameter (17) to the node (2) for at least some of connection (11) that are to be activated, said parameter (11) indicating whether the respective connection (11) is available to be assigned in the node (2) to received packets (6).

8. Method according to claim 7, wherein the value of said parameter (17) indicates that no packets (6) are to be assigned to the corresponding connection (11) in case at least one of the packet filter values (16) required for the connection (11) is not available, and wherein the value of said parameter (17) indicates that packets (6) can be assigned to the connection (11) if the corresponding packet values match with the packet filter values (16) associated with said connection (11) in case all packet filter values (16) required for said connection (11) are available.

9. Method according to claim 7 or 8, wherein in case a parameter (17) was transmitted by the mobile station (1) indicating that the corresponding connection (11) is not to be assigned in the node (2) to received packets (6), the mobile station (1) transmits to the node (2), as soon as all packet filter values (16) required for said connection (11) are available, said required packet filter values (16) together with a new value of the parameter (17) indicating that the corresponding connection (11) can be assigned to received packets (6).

10. Method according to one of claims 7 to 9, wherein the wireless access network is a UMTS (Universal Mobile Telecommunications System) radio access network, wherein the node is a GGSN (Gateway General Packet Radio System Support Node) (2), wherein the mobile station (1) has access to the GGSN (2) via the UMTS radio access network, an SGSN (Serving General Packet Radio Service Support Node) and an IP (Internet Protocol) based packet domain PLMN (Public Land Mobile Network) backbone network, wherein the to be activated connection (11) is a secondary PDP (Packet Data Protocol) context, and wherein the packet filter values (16) are sent by the mobile station (1) to the GGSN (2) in a packet filter (13) of a TFT (Traffic Flow Template) (12) associated with the to be activated secondary PDP context (11).

11. Mobile station (1) for a radio communications system, said mobile station (1) being able to access a node (2) operating as a gateway to a packet-switched network via a wireless access network, said mobile station (1) comprising:
means for associating packet filter values (16) with connections (11) that are to be used for transferring user data between said node (2) and said mobile station (1), the packet filter values (16) being selected such that they correspond to values of packets (6) received by said node (2) from said packet-switched network that are to use said connection (11), and for setting a parameter (17) to a first predetermined value in case all packet filter values (16) required for a specific connection (11) with which packet filter values (16) are to be associated are known by said mobile station (1) and to a second predetermined value in case not all packet filter values (16) required for a specific connection (11) with which packet filter values (16) are to be associated are known by said mobile station (1); and
means for transmitting packet filter values (16) associated with a specific connection (11) and the value of said parameter (17) associated with a specific connection (11) to said node (2).

12. Network element comprising a node (2) operating as a gateway between a radio communications network and a packet-switched network, said node (2) including
means for receiving from a mobile station (1) packet filter values (16) associated with a specific connection (11) that is to be used for a transfer of user data between said node (2) and said mobile station (1), and for receiving a parameter (17) associated with such a specific connection (11) indicating whether the specific connection (11) is to be used;
means for storing the received packet filter values (16) and the value of the parameter (17);
means for comparing values included in a packet (6) received from the packet-switched network with those stored packet filter values (16) associated with a connection (11) with which a parameter value (17) is associated that indicates that said connection (11) is available to be used, and for assigning said packet (6) to a connection (11) with packet filter values (16) matching to the values of said packet (6) for a transfer of said packet (6) to said mobile station (1).

13. Communications system comprising a mobile station (1), a radio access network, a support node connected to said radio access network, and a gateway (2) connected to said support node via a core network, said gateway (2) providing an access to an external packet-switched network, wherein said node is accessible by the mobile station (1) via a radio access network, said mobile station (1) including means for associating packet filter values (16) with a connection (11) that is to be used for transferring specific user data between said mobile station (1) and said gateway (2), the associated packet filter values (16) being selected such that they correspond to header field values of packets (6) received by the gateway (2) from said external packet-switched network that are to use said connection (11), said means being designed for setting a parameter (17) to a first predetermined value in case all packet filter values (16) required for a connection (11) with which packet filter values (16) are to be associated are known and to a second predetermined value in case not all packet filter values (16) required for a connection (11) with which packet filter values (16) are to be associated are known, wherein said mobile station (1) further includes means for transmitting packet filter values (16) associated with a specific connection (11) and the value of said parameter (17) to said gateway (2), and wherein said gateway (2) includes means for comparing header field values of packets (6) received from said packet-switched network with received packet filter values (16) associated with connections to which the first predetermined value of said parameter (17) is associated, and for assigning the packets (6) to connections (11) with associated matching packet filter values (16).
